(19) United States
(12) Patent Application Publication
(10) Pub. No.: US 2010/0154837 A1
(43) Pub. Date: Jun. 24, 2010

(54) Liquid-scattering prevention cup, substrate processing apparatus and method for operating the apparatus

(75) Inventors: Takahiro Ogawa, Tokyo (JP); Naoki Matsuda, Tokyo (JP); Koichi Fukaya, Tokyo (JP); Hiroyuki Kaneko, Tokyo (JP)

Correspondence Address: WENDEROTH, LIND & PONACK, L.L.P., 1030 15th Street, N.W.,, Suite 400 East, Washington, DC, 20005-1503, US

(73) Assignee: Ebara Corporation

(21) Appl. No.: 12/654,437

(22) Filed: Dec. 18, 2009

(30) Foreign Application Priority Data
Dec. 24, 2008 (JP) 2008-327331

(51) Int. Cl. B08B 3/00

(52) U.S. Cl. 134/32; 134/104.2

(57) ABSTRACT

A liquid-scattering prevention cup, provided in a substrate processing apparatus, is capable of attaching a hydrophilic member, such as a PVA sponge, to an inner surface of a liquid-scattering prevention cup body easily and efficiently. The liquid-scattering prevention cup includes a liquid-scattering prevention cup body, and a liquid-scattering prevention sheet having a surface hydrophilic material layer, attached to an entire area or a predetermined area of the inner surface of the liquid-scattering prevention cup body. The liquid-scattering prevention sheet has been attached to the liquid-scattering prevention cup body by an attachment such that the hydrophilic material layer is exposed.

### BACKGROUND OF THE INVENTION

1. Field of the Invention

The present invention relates to a liquid-scattering prevention cup, surrounding a substrate held by a substrate rotating mechanism, for preventing scattering of a processing liquid coming away from the substrate. The liquid-scattering prevention cup is provided in a substrate processing apparatus which includes the substrate rotating mechanism for holding and rotating a substrate, such as a semiconductor wafer, a glass substrate, a liquid crystal panel, etc., and which supplies a processing liquid to the substrate to process the substrate and, after the processing, rotates the substrate and causes the processing liquid to leave the substrate by the centrifugal force. The present invention also relates to a substrate processing apparatus provided with the liquid-scattering prevention cup, and to a method for operating the substrate processing apparatus.

2. Description of the Related Art

In a semiconductor device manufacturing process, for example, after carrying out copper plating or CMP (chemical mechanical polishing) processing of a surface of a substrate, such as a semiconductor wafer, cleaning of the substrate is generally carried out to remove impurities or contaminants.

A well-known substrate cleaning apparatus (substrate processing apparatus) for carrying out cleaning process of substrates includes a substrate rotating mechanism for horizontally holding and rotating a substrate, and processing liquid supply sections (processing liquid supply nozzles) for supplying a processing liquid, such as a chemical solution or pure water, to a front and back surfaces of the substrate held by the substrate rotating mechanism. This apparatus carries out cleaning of a substrate by supplying the processing liquid while rotating the substrate, and subsequently supplying pure water for rinsing to the substrate. After the cleaning of the substrate, it is common practice to spin-dry the substrate by rotating it at a high speed so as to remove a liquid from the substrate by the centrifugal force.

In such a substrate cleaning apparatus, it is a conventional practice to use a liquid-scattering prevention cup, disposed such that it surrounds a periphery of a substrate held by a substrate rotating mechanism, in order to prevent liquid droplets, which leave the rotating substrate by the centrifugal force during spin-drying, from scattering out over a long distance. While such a conventional liquid-scattering prevention cup can prevent long-distance scattering of liquid droplets, it generally cannot prevent liquid droplets, coming away from a substrate and colliding with an inner surface of the cup, from bouncing off and scattering from the inner surface. The liquid droplets, which have bounced off the inner surface of the liquid-scattering prevention cup, can re-attach to the substrate, which may result in the formation of watermarks on the substrate surface. Such watermarks can cause a leak or poor adhesion in the watermark portion of the substrate, leading to lowering of the product yield. How to reduce the formation of watermarks is therefore an important problem.

A technique for preventing liquid droplets from bouncing off an inner surface of a liquid-scattering prevention cup is known. This technique involves attaching a hydrophilic member to an inner surface of a liquid-scattering prevention cup body so that liquid droplets, which have collided with the inner surface of the liquid-scattering prevention cup body, will be absorbed into the hydrophilic member (see, for example, Japanese Patent Laid-Open Publication No. 2003-100687). Bouncing of liquid droplets on the inner surface of the cup can thus be suppressed.

### SUMMARY OF THE INVENTION

A PVA sponge, for example, is known to be usable as a hydrophilic member to be attached to an inner surface of a liquid-scattering prevention cup body. Such a member is very soft when it is thin, and therefore, it is very difficult to uniformly and firmly attach such a member to an inner surface of a liquid-scattering prevention cup body having a three-dimensional shape, without producing a wrinkle.

The present invention has been made in view of the above situation in the background art. It is therefore an object of the present invention to provide a liquid-scattering prevention cup, provided in a substrate processing apparatus, which is capable of attaching a hydrophilic member, such as a PVA sponge, to an inner surface of a liquid-scattering prevention cup body easily and efficiently.

It is another object of the present invention to provide a substrate processing apparatus which can keep a layer of a hydrophilic material such as a PVA sponge, provided in an inner surface of a liquid-scattering prevention cup, in a wet state by a wetting section of simple construction, and can prevent liquid droplets from bouncing off the inner surface of the liquid-scattering prevention cup and re-attaching to a substrate surface, and to provide a method for operating the substrate processing apparatus.

In order to achieve the above objects, the present invention provides a liquid-scattering prevention cup, provided in a substrate processing apparatus comprising a substrate rotating mechanism for holding and rotating a substrate, and the liquid-scattering prevention cup, disposed such that it surrounds a periphery of the substrate held by the substrate rotating mechanism, for preventing scattering of liquid droplets coming away from the rotating substrate. The liquid-scattering prevention cup comprises a liquid-scattering prevention cup body, and a liquid-scattering prevention sheet having a surface hydrophilic material layer, attached to an entire area or a predetermined area of the inner surface of the liquid-scattering prevention cup body. The liquid-scattering prevention sheet has been attached to the liquid-scattering prevention cup body by an attachment such that the hydrophilic material layer is exposed.

In a preferred aspect of the present invention, the attachment attaches the opposite side of the liquid-scattering prevention sheet from the hydrophilic material layer to the inner surface of the liquid-scattering prevention cup body with an adhesive.

In a preferred aspect of the present invention, the attachment detachably attaches the opposite side of the liquid-scattering prevention sheet from the hydrophilic material layer to the inner surface of the liquid-scattering prevention cup body by using an attachment jig.

In a preferred aspect of the present invention, the liquid-scattering prevention sheet is comprised of a plurality of liquid-scattering prevention sheet pieces, each having been cut into a predetermined shape adapted for close contact with the inner surface of the liquid-scattering prevention cup body, and each comprising a resin sheet and the surface hydrophilic material layer attached to the resin sheet via an adhesive.

In a preferred aspect of the present invention, the liquid-scattering prevention sheet has been cut into a predetermined shape adapted for close contact with the inner surface of the liquid-scattering prevention cup body, comprises an elastic sheet and the surface hydrophilic material layer attached to the elastic sheet via an adhesive, and has been attached to the inner surface of the liquid-scattering prevention cup body by inserting it into the liquid-scattering prevention cup body through elastic deformation of the liquid-scattering prevention sheet, and bringing the elastic sheet into close contact with the inner surface of liquid-scattering prevention cup body through the elastic restoring force of the elastic sheet.

In a preferred aspect of the present invention, the liquid-scattering prevention sheet, attached to the inner surface of the liquid-scattering prevention cup body, has a seam which is inclined from the vertical direction of the liquid-scattering prevention cup body toward a direction opposite to the rotating direction of the substrate rotating mechanism.

The present invention also provides a substrate processing apparatus comprising a substrate rotating mechanism for holding and rotating a substrate, and a liquid-scattering prevention cup, disposed such that it surrounds the periphery of the substrate held by the substrate rotating mechanism, for preventing scattering of a liquid coming away from the rotating substrate. A hydrophilic material layer for preventing liquid droplets, coming away from the rotating substrate, from bouncing off the inner surface of the liquid-scattering prevention cup is provided in part or all of the inner surface of the liquid-scattering prevention cup. The substrate processing apparatus further includes a wetting section for supplying a rinsing liquid to the hydrophilic material layer to keep the hydrophilic material layer in a wet state.

In a preferred aspect of the present invention, the wetting section includes a plurality of rinsing liquid spray nozzles disposed such that the rinsing liquid is uniformly supplied to a surface of the hydrophilic material layer.

The rinsing liquid spray nozzles may be disposed below the liquid-scattering prevention cup.

Alternatively, the rinsing liquid spray nozzles may be disposed in the vicinity of the liquid-scattering prevention cup.

Preferably, the rinsing liquid spray nozzles are each provided with a spray angle adjustment mechanism for adjusting the angle of spray of the rinsing liquid to adjust the position of a spray spot on the surface of the hydrophilic material layer.

The present invention also provides a method for operating a substrate processing apparatus comprising a substrate rotating mechanism for holding and rotating a substrate, and a liquid-scattering prevention cup, disposed such that it surrounds the periphery of the substrate held by the substrate rotating mechanism, for preventing scattering of a liquid coming away from the rotating substrate. The method comprises providing in part or all of an inner surface of the liquid-scattering prevention cup a hydrophilic material layer for preventing liquid droplets, coming away from the rotating substrate, from bouncing off the inner surface of the liquid-scattering prevention cup, and supplying a rinsing liquid from a rinsing liquid supply section to the hydrophilic material layer during idling of the apparatus to keep the hydrophilic material layer in a wet state.

Preferably, the rinsing liquid supply section includes a rinsing liquid spray nozzle.

According to the liquid-scattering prevention cup of the present invention, the liquid-scattering prevention sheet having a surface hydrophilic material layer is attached by an attachment to an entire area or a predetermined area of the inner surface of the liquid-scattering prevention cup body such that the hydrophilic material layer is exposed. This makes it possible to easily and closely attach the hydrophilic material to the inner surface of the liquid-scattering prevention cup body having a three-dimensional curve even when the hydrophilic material is a thin sheet-like member, such as a PVA sponge.

The liquid-scattering prevention sheet, attached to the inner surface of the liquid-scattering prevention cup body, may have a seam which is inclined from the vertical direction of the liquid-scattering prevention cup body toward a direction opposite to the rotating direction of the substrate rotating mechanism. This can reduce bouncing of a processing liquid on the seam of the liquid-scattering prevention sheet.

According to the substrate processing apparatus of the present invention, the provision of the wetting section can keep the hydrophilic material layer, provided in the inner surface of the liquid-scattering prevention cup, in a wet state during idling of the substrate processing apparatus and can thereby prevent drying of the hydrophilic material layer. At the start of processing of a substrate, liquid droplets, coming away from the substrate, collide with the soft hydrophilic material layer in a wet state and are absorbed into the layer, whereby bouncing of the liquid droplets on the layer can be suppressed. Therefore, re-attachment of liquid droplets, bouncing off the hydrophilic material layer, to the substrate can be reduced.

According to the method for operating a substrate processing apparatus of the present invention, a rinsing liquid is supplied from the rinsing liquid supply section to the hydrophilic material layer during idling of the apparatus to keep the hydrophilic material layer in a wet state. This can prevent liquid droplets, coming away from a substrate, from bouncing off the hydrophilic material layer and re-attaching to the substrate during processing of the substrate.

### BRIEF DESCRIPTION OF THE DRAWINGS

FIG. 1 is an external view of a liquid-scattering prevention cup according to an embodiment of the present invention;

FIG. 2 is a cross-sectional view of a liquid-scattering prevention cup according to another embodiment of the present invention;

FIG. 3 is a partial cross-section of the sidewall of a liquid-scattering prevention cup according to the present invention;

FIG. 4 is an external view of a liquid-scattering prevention cup according to still another embodiment of the present invention;

FIG. 5 is a cross-sectional view of a liquid-scattering prevention cup according to still another embodiment of the present invention;

FIG. 6 is a schematic external view of a substrate processing apparatus according to an embodiment of the present invention;

FIG. 7 is a schematic plan view of the substrate processing apparatus according to an embodiment of the present invention;

FIG. 8A is a cross-sectional view taken along line B-B of FIG. 7, and FIG. 8B is a cross-sectional view taken along line A-A of FIG. 7;

FIG. 9 is a diagram schematically showing the overall construction of another embodiment of a substrate processing apparatus provided with a liquid-scattering prevention cup;

FIG. 10 is a diagram illustrating the operation of the substrate processing apparatus shown in FIG. 9;

FIG. 11 is a diagram illustrating the operation of the substrate processing apparatus shown in FIG. 9;

FIG. 12 is a diagram illustrating the operation of the substrate processing apparatus shown in FIG. 9;

FIG. 13 is a diagram illustrating the operation of the substrate processing apparatus shown in FIG. 9;

FIG. 14 is a diagram illustrating the operation of the substrate processing apparatus shown in FIG. 9;

FIG. 15 is a diagram illustrating the operation of the substrate processing apparatus shown in FIG. 9;

FIG. 16 is a diagram illustrating the operation of the substrate processing apparatus shown in FIG. 9;

FIG. 17 is a diagram illustrating the operation of the substrate processing apparatus shown in FIG. 9;

FIG. 18 is a diagram illustrating the operation of the substrate processing apparatus shown in FIG. 9;

FIGS. 19A through 19C are diagrams illustrating various methods for attaching a liquid-scattering prevention sheet to a liquid-scattering prevention cup body;

FIG. 20 is an external view of a liquid-scattering prevention cup according to still another embodiment of the present invention; and

FIGS. 21A through 21C are diagrams illustrating the formation of watermarks on a semiconductor substrate as observed when the substrate is cleaned by a substrate processing apparatus according to the present invention or a conventional substrate processing apparatus.

### DETAILED DESCRIPTION OF THE PREFERRED EMBODIMENTS

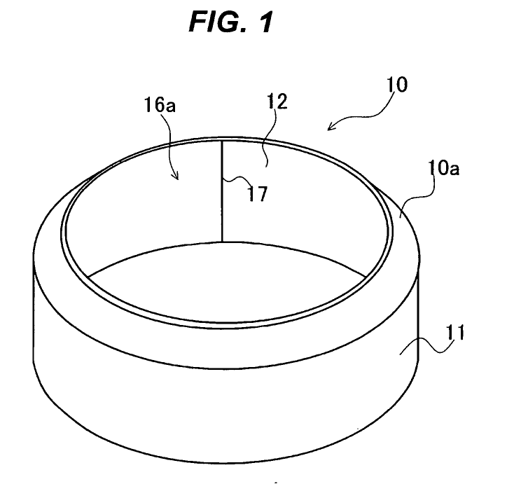

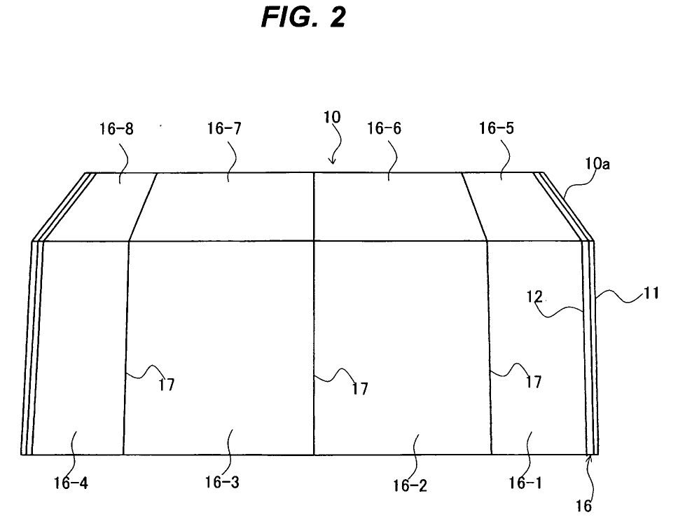

Preferred embodiments of the present invention will now be described with reference to the drawings. FIG. 1 is an external view showing a liquid-scattering prevention cup according to an embodiment of the present invention, and FIG. 2 is a cross-sectional view showing a liquid-scattering prevention cup according to another embodiment of the present invention. The liquid-scattering prevention cup 10 shown in FIG. 1 or 2 is generally cylindrical and has an inwardly inclined portion 10a at its upper end. The liquid-scattering prevention cup 10 is comprised of a liquid-scattering prevention cup body 11 formed of a resin material (e.g., PET), and a liquid-scattering prevention sheet 16 having a surface hydrophilic material layer 12, attached to an inner surface of the liquid-scattering prevention cup body 11 with the surface hydrophilic material layer 12 exposed inside the liquid-scattering prevention cup 12. Although in this embodiment an upper end and a lower end of the cylindrical portion of the liquid-scattering prevention cup 10 have the same diameter, the diameter of the upper end and the diameter of the lower end need not necessarily be equal. For example, the diameter of the lower end may be larger than the diameter of the upper end.

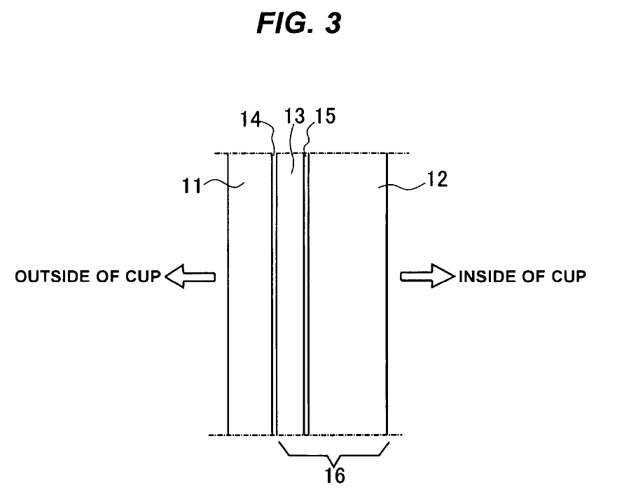

As shown in FIG. 3, the liquid-scattering prevention sheet 16 is comprised of a sheet material 13 and a hydrophilic material layer 12 attached to the sheet material 13 via an adhesive 15. In this embodiment, a PVC sheet is used as the sheet material 13, and a PVA sponge having a pore size of 150 to 180 μm and a porosity of 89 to 90% is used as the hydrophilic material layer 12. A PVA sponge having a pore size of 10 to 900 μm and a porosity of 10 to 99% may be used as the hydrophilic material layer 12. An acrylic adhesive is used as the adhesive 15. In this embodiment, the sheet material 13 of the liquid-scattering prevention sheet 16 is attached to the inner surface of the liquid-scattering prevention cup body 11 with an adhesive 14. An acrylic resin adhesive, for example, is used as the adhesive 14.

The sheet material 13 is not limited to a PVC sheet: A resin sheet (having a water absorption rate of not more than 0.5%), such as PET, polyacrylate, PEEK, PP, PE, etc., may be used. The hydrophilic material is not limited to a PVA sponge: Any water-retentive, highly water-absorptive resin material having a hydrophilic group, such as a polyurethane sponge, may be used. The adhesive 14 for bonding the sheet material 13 to the inner surface of the liquid-scattering prevention cup body 11 is not limited to a synthetic adhesive, such as an acrylic resin adhesive: It is possible to use a natural adhesive. An elastic material is preferably used as the sheet material 13, as will be described later.

As shown in FIG. 2, the liquid-scattering prevention sheet may be comprised of a plurality of liquid-scattering prevention sheet pieces 16-1, 16-2, 16-3 . . . , each having been cut into a predetermined shape adapted for close contact with the inner surface of the liquid-scattering prevention cup body 11. The liquid-scattering prevention sheet pieces 16-1, 16-2, 16-3 . . . are attached to the inner surface of the liquid-scattering prevention cup body 11 with seams 17 formed between the adjacent sheet pieces. Alternatively, as shown in FIG. 1, a single liquid-scattering prevention sheet 16a, which has been cut into a predetermined shape adapted for close contact with the inner surface of the liquid-scattering prevention cup body 11, may be attached to the inner surface of the liquid-scattering prevention cup body 11 with a seam 17 formed.

The single long liquid-scattering prevention sheet 16a, which has been cut into a predetermined shape adapted for close contact with the inner surface of the liquid-scattering prevention cup body 11 having a three-dimensional curve, is rolled and inserted into the liquid-scattering prevention cup body 11, and the rolled liquid-scattering prevention sheet 16a is expanded in the liquid-scattering prevention cup body 11. By the elastic restoring force of the sheet material 13 of the liquid-scattering prevention sheet 16a, the sheet material 13 comes into close contact with the inner surface of the liquid-scattering prevention cup body 11. This facilitates attachment of the liquid-scattering prevention sheet 16a to the inner surface of the liquid-scattering prevention cup body 11 by an adhesive or an attachment jig. When the sheet material 13 has a strong elastic restoring force, the liquid-scattering prevention sheet 16a can be attached to the inner surface of the liquid-scattering prevention cup body 11 only by the elastic restoring force of the sheet material 13 or by using a simple attachment jig.

It is a very difficult work to attach a thin PVA sponge sheet, e.g., having a thickness of 3 mm, directly and uniformly to the inner surface of the liquid-scattering prevention cup body 11. According to the present invention, the hydrophilic material attachment work can be made significantly easier by using the liquid-scattering prevention sheet 16 which is comprised of either a single sheet or a plurality of sheet pieces, having a predetermined shape adapted for close contact with the inner surface of the liquid-scattering prevention cup body 11, and which has been prepared by bonding and attaching a PVA sponge sheet to the resin sheet material 13, for example, a PVC sheet having a thickness of 0.5 mm, and bonding and mounting the liquid-scattering prevention sheet 16 to the inner surface of the liquid-scattering prevention cup body 11 with the adhesive 14.

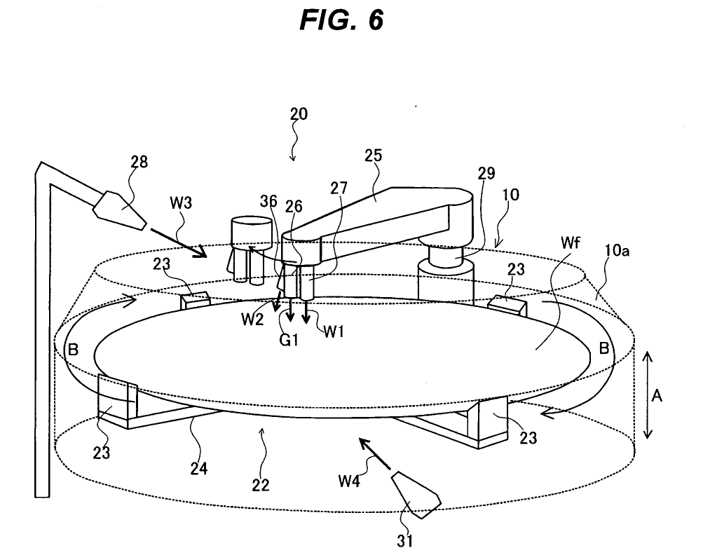

FIG. 6 is a diagram schematically showing the construction of a substrate cleaning apparatus (substrate processing apparatus), provided with the above-described liquid-scattering prevention cup 10, for cleaning a substrate such as a semiconductor wafer. The substrate cleaning apparatus 20 includes a cleaning tank, which will be described in detail later, and a substrate rotating mechanism 22, disposed in the cleaning tank, for holding a periphery of a substrate Wf, such as a semiconductor wafer, and rotating the substrate. The substrate rotating mechanism 22 includes a spinning wheel 24 supported by a rotating shaft (not shown), and is configured to rotate the spinning wheel 24 in the direction of arrow B in a horizontal plane by a rotary drive section (not shown). The spinning wheel 24 is provided with a plurality of holding members 23 (e.g., four members as shown in FIG. 6) for holding the periphery of the substrate Wf. The liquid-scattering prevention cup 10 is disposed such that it surrounds the substrate rotating mechanism 22. The liquid-scattering prevention cup 10 is vertically movable as shown by arrow A by a lifting mechanism (not shown).

Reference numeral 25 denotes a pivot arm. To one end of the pivot arm 25 are mounted a gas supply nozzle 26 for supplying a dry gas (IPA gas) G1 to the substrate Wf held on the spinning wheel 24, a liquid supply nozzle 27 for supplying a liquid W1 to the substrate Wf, and a cover rinsing nozzle 36 for supplying a rinsing liquid W2 to the substrate Wf for covering the substrate Wf with the rinsing liquid W2. The other end of the pivot arm 25 is supported by a pivot shaft 29. The pivot arm 25 is configured to move the gas supply nozzle 26, the liquid supply nozzle 27 and the cover rinsing nozzle 36 in the radial direction of the substrate Wf. Reference numeral 28 denotes an upper substrate surface rinsing nozzle for supplying a rinsing liquid W3 to an upper surface of the substrate Wf held by the holding members 23 of the spinning wheel 24, and reference numeral 31 denotes a lower substrate surface rinsing nozzle for supplying a rinsing liquid W4 to a lower surface of the substrate Wf.

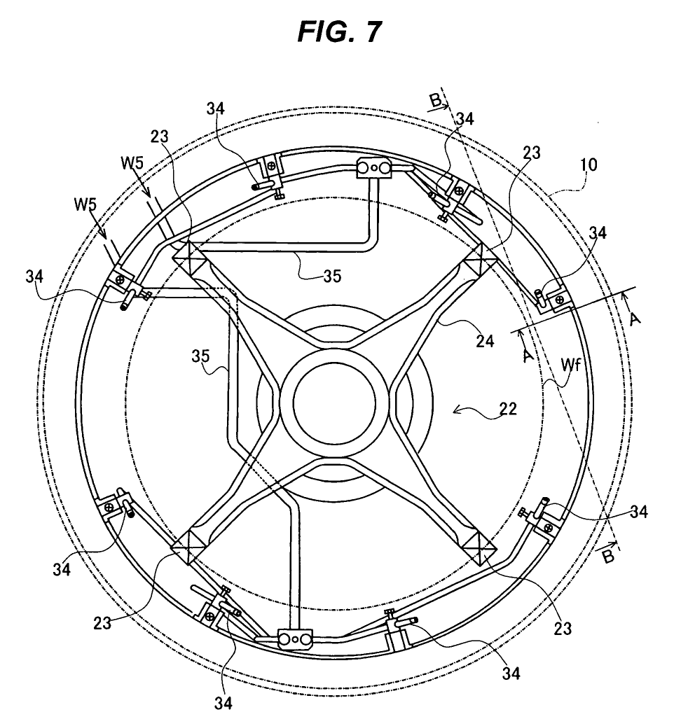

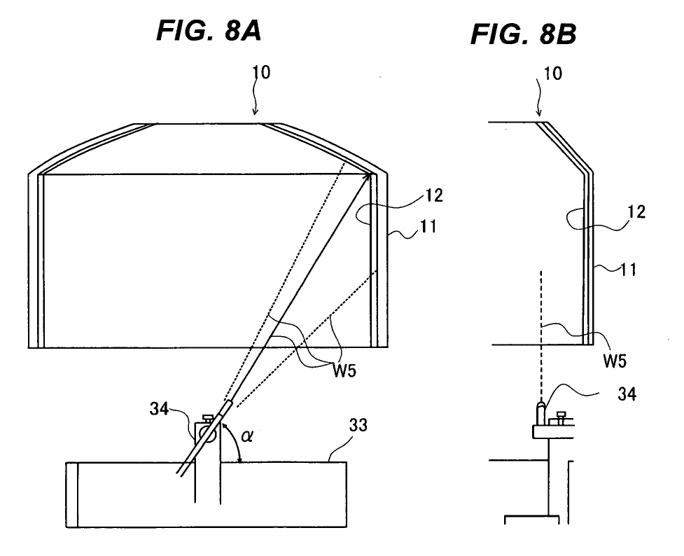

FIG. 7 is a plan view of a lower portion of the substrate cleaning apparatus 20 (mainly showing cup-rinsing nozzles 34 and their layout), FIG. 8A is a cross-sectional view taken along line B-B of FIG. 7, and FIG. 8B is a cross-sectional view taken along line A-A of FIG. 7. As shown in the Figures, a nozzle stage 33 is provided below the liquid-scattering prevention cup 10. A plurality of cup-rinsing nozzles 34 (e.g., 8 nozzles as shown in FIG. 7) for supplying a rinsing liquid W5 to the hydrophilic material layer 12 in the inner surface of the liquid-scattering prevention cup 10 are mounted on the nozzle stage 33. These cup-rinsing nozzles 34 are arranged circumferentially at regular intervals so that the rinsing liquid W5 can be supplied uniformly over an entire circumference of the hydrophilic material layer 12 of the liquid-scattering prevention cup 10.

Each cup-rinsing nozzle 34 is connected to one of pipes 35, 35; and the rinsing liquid W5 is sprayed from each cup-rinsing nozzle 34 toward the hydrophilic material layer 12 in the inner surface of the liquid-scattering prevention cup 10 by supplying the rinsing liquid W5 to the pipes 35, 35. Each cup-rinsing nozzle 34 is capable of adjusting the angle α of spray of the rinsing liquid W5 so that the position of a spray spot on the hydrophilic material layer 12 can be adjusted. The rinsing liquid W5 may preferably be supplied to an upper or top portion of the hydrophilic material layer 12: Because of penetration of the rinsing liquid into the hydrophilic material layer 12 as well as downward flow of the rinsing liquid, the hydrophilic material layer 12 can be wetted uniformly in a short time by supplying the rinsing liquid to the upper or top portion of the hydrophilic material layer 12.

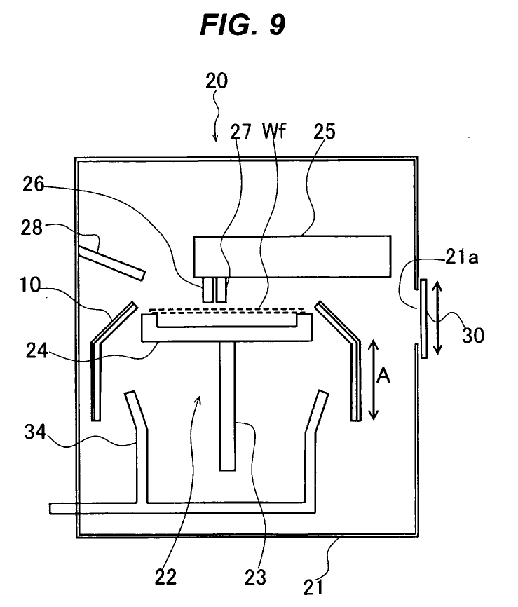

FIG. 9 is a diagram schematically showing the overall construction of another substrate cleaning apparatus (substrate processing apparatus) provided with the above-described liquid-scattering prevention cup 10. The substrate cleaning apparatus 20 is disposed in a cleaning tank 21. In this embodiment, the cover rinsing nozzle 36 mounted to the pivot arm 25 is omitted, and the upper substrate surface rinsing nozzle 28 is mounted to the inner wall surface of the cleaning tank 21. The spinning wheel 24 is rotated in a horizontal plane by a not-shown rotary drive section. The liquid-scattering prevention cup 10 is disposed such that it surrounds the substrate rotating mechanism 22. The liquid-scattering prevention cup 10 is vertically movable as shown by arrow A by a lifting mechanism (not shown).

The pivot arm 25 is disposed in an upper position in the cleaning tank 21. To the pivot arm 25 are mounted a gas supply nozzle 26 for jetting a dry gas toward a substrate Wf held on the spinning wheel 24, and a water supply nozzle 27 for spraying water toward the substrate Wf. The gas to be jetted from the gas supply nozzle 26 typically is an inert gas, such as nitrogen gas. The gas may contain the vapor of a substance which, when dissolved in water, lowers the surface tension. Such a substance may be exemplified by a hydrophilic solvent, such as isopropyl alcohol (IPA), diacetone alcohol, ethyl glycol, ethyl acetate or methylpyrrolidone, or a mixture thereof. Water to be supplied from the water supply nozzle 27 typically is pure water. Depending on the intended purpose, however, it is possible to use deionized water, carbon dioxide-containing water or functional water (hydrogen-containing water, ion-containing water, etc.), from which dissolved salts or dissolved organic matter maybe removed, or an alcohol, such as IPA, or an organic solvent.

The upper substrate surface rinsing nozzle 28 is a nozzle for spraying a rinsing liquid onto the upper surface of the substrate Wf held on the spinning wheel 24, and the cup-rinsing nozzles 34 are nozzles for cleaning the inner surface of the liquid-scattering prevention cup 10. The cup-rinsing nozzles 34 may be disposed to another place of the liquid-scattering prevention cup 10, such as near the inner surface of the liquid-scattering prevention cup body 11, or near the inwardly inclined portion 10a. Although not shown diagrammatically, a lower substrate surface rinsing nozzle for spraying a rinsing liquid onto the lower surface of the substrate Wf is also provided. As with the water to be supplied from the water supply nozzle 27, pure water, deionized water, carbon dioxide-containing water, an alcohol such as IPA, an organic solvent, etc. can be used as the rinsing liquid to be supplied from the lower substrate surface rinsing nozzle. The cleaning tank 21 is provided with a transfer port 21a for carrying in and out a substrate, and a shutter 30 for opening and closing the transfer port 21a.

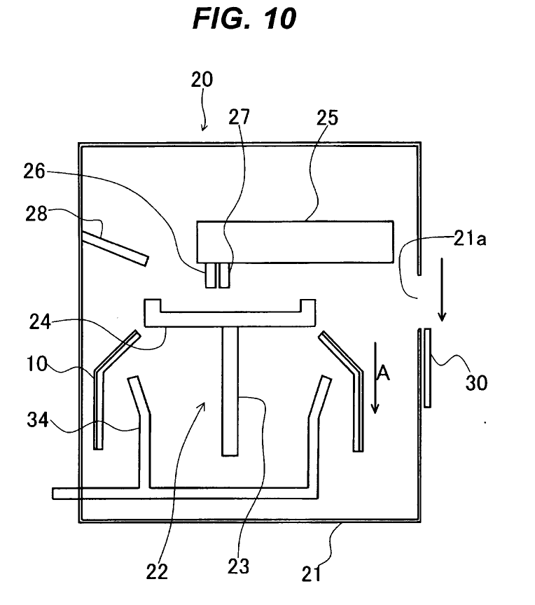

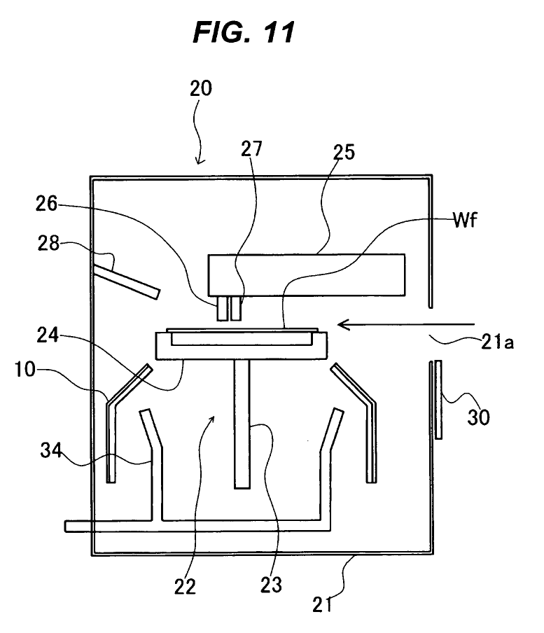

FIGS. 10 through 18 are diagrams illustrating the operation of the substrate cleaning apparatus 20 in a substrate cleaning/drying process. The operation of the substrate cleaning apparatus 20 will now be described with reference to FIGS. 10 through 18. As shown in the Figures, the substrate cleaning apparatus 20 is disposed in the cleaning tank 21. First, as shown in FIG. 10, the liquid-scattering prevention cup 10 is lowered until its upper end comes to be positioned below the spinning wheel 24 and, at the same time, the shutter 30 is lowered to open the transfer port 21a of the cleaning tank 21. In this state, a substrate Wf is carried from the transfer port 21a into the cleaning tank 21 by a substrate transfer means (not shown), such as a robot arm, and placed the substrate on the spinning wheel 24, as shown in FIG. 11. The substrate Wf on the spinning wheel 24 is held (gripped), at its periphery, by the not-shown holding members.

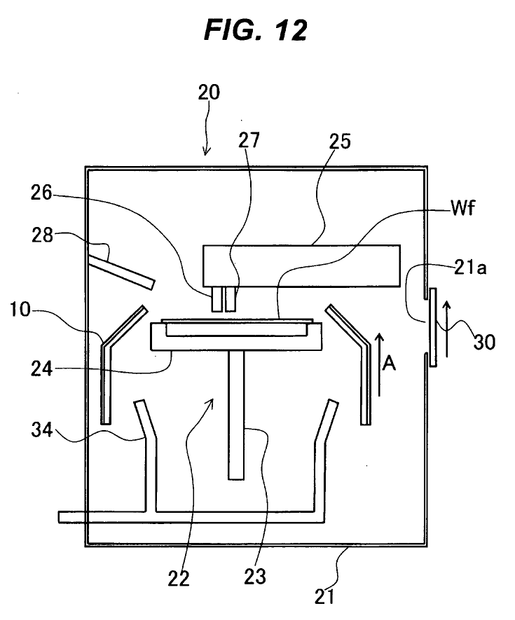

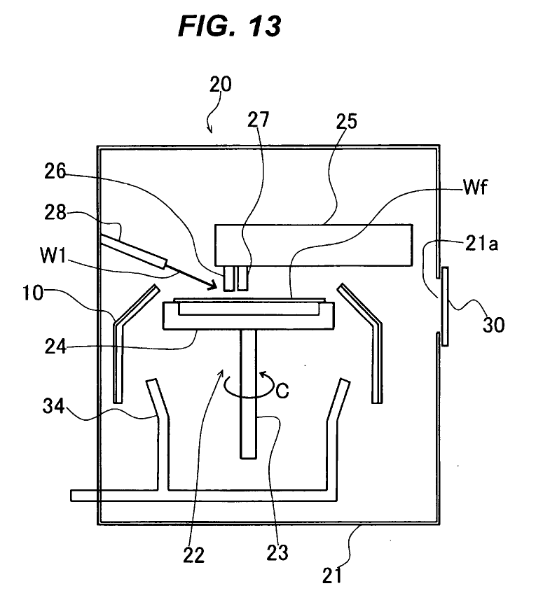

Next, as shown in FIG. 12, the liquid-scattering prevention cup 10 is raised until its upper end comes to be positioned above the spinning wheel 24 and, at the same time, the shutter 30 is raised to close the transfer port 21a of the cleaning tank 21, whereby the periphery of the substrate Wf is surrounded by the liquid-scattering prevention cup 10. Thereafter, as shown in FIG. 13, the rotating shaft 23 is rotated in the direction of arrow C by the not-shown rotary drive section, thereby rotating the substrate Wf, held on the spinning wheel 24, in the same direction. While rotating the substrate Wf at a rotational speed of about 300 rpm, a rinsing liquid W1 is supplied from the upper substrate surface rinsing nozzle 28 to the upper surface of the substrate Wf to rinse the upper surface of the substrate Wf. A rinsing liquid is supplied also to the lower surface of the substrate Wf from the not-shown lower substrate surface rinsing nozzle to rinse the lower surface of the substrate Wf.

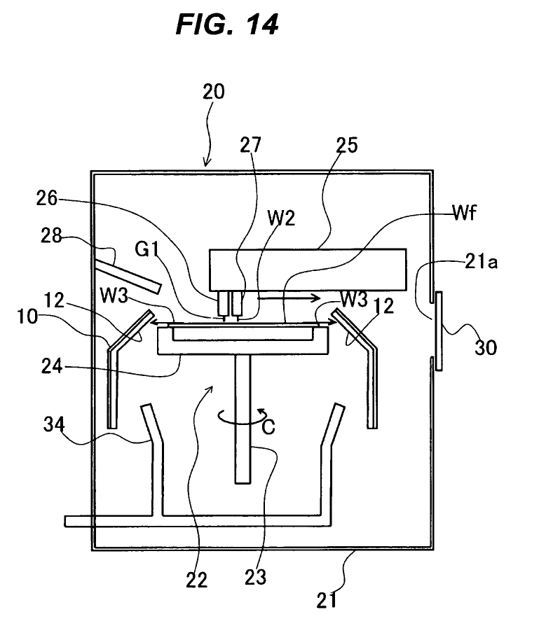

Next, as shown in FIG. 14, a drying process is carried out by supplying IPA gas G1 and a rinsing liquid W2 to the rotating substrate Wf from the gas supply nozzle 26 and the water supply nozzle 27, respectively. During the drying process, while rotating the substrate Wf at a rotational speed of about 300 rpm and supplying the IPA gas G1 and the rinsing liquid W2, the pivot arm 25 is moved so that the gas supply nozzle 26 and the water supply nozzle 27 move to the edge of the substrate Wf. The rotational speed of the substrate Wf is reduced to 150 rpm when the nozzles have reached a generally intermediate position between the center and the edge of the substrate Wf. In the drying process, the rinsing liquid W2, supplied to the rotating substrate Wf, comes away from the periphery of the substrate Wf by the centrifugal force due to the rotation of the substrate Wf. The rinsing liquid W3, coming away from the substrate Wf, collides with the hydrophilic material layer 12 of PVA sponge, provided in the inner surface of the liquid-scattering prevention cup 10. Because the hydrophilic material layer 12 is in a wet state, the rinsing liquid is absorbed into the layer 12, whereby bouncing of the rinsing liquid on the layer 12 is suppressed. Therefore, re-attachment of the rinsing liquid, bouncing off the inner surface of the liquid-scattering prevention cup 10, to the dried surface of the substrate Wf can be reduced.

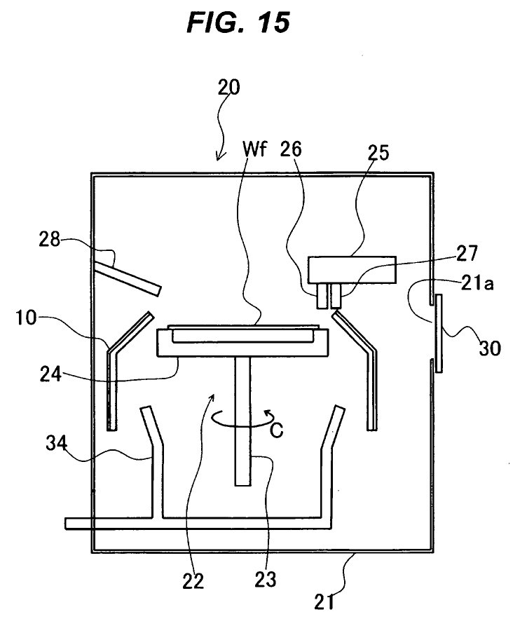

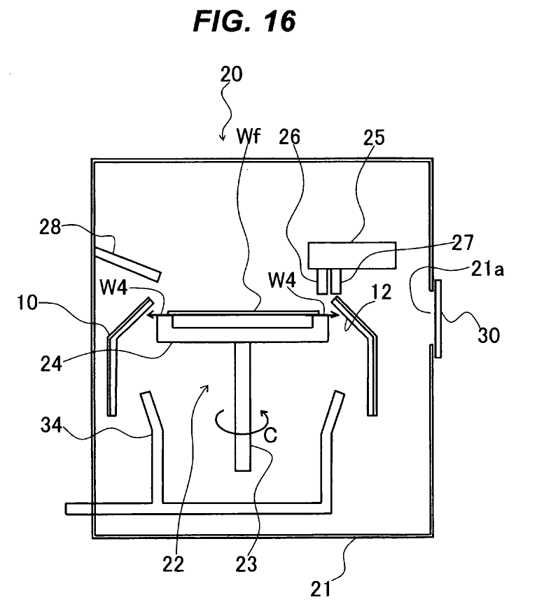

The drying process is completed in about 40 seconds. Upon completion of the drying process, the supply of the IPA gas G1 and the rinsing liquid W2 from the gas supply nozzle 26 and the water supply nozzle 27 is stopped, as shown in FIG. 15. Thereafter, as shown in FIG. 16, a drying process for the lower surface of the substrate Wf is started. In the drying process for the lower surface of the substrate Wf, the rotational speed of the spinning wheel 24 is increased to about 1500 rpm and the rotational speed is maintained for 30 seconds to carry out the so-called spin-drying. By the strong centrifugal force due to the increased rotational speed of the spinning wheel 24, the rinsing liquid W4, adhering to the lower surface of the substrate Wf, comes away from the lower surface and strongly collides with the inner surface of the liquid-scattering prevention cup 10. However, owing to the liquid-absorbing effect of the hydrophilic material layer 12 of PVA sponge in a wet state, bouncing of the rinsing liquid on the layer 12 is suppressed. Therefore, re-attachment of the rinsing liquid, bouncing off the inner surface of the liquid-scattering prevention cup 10, to the surface of the substrate Wf can be reduced.

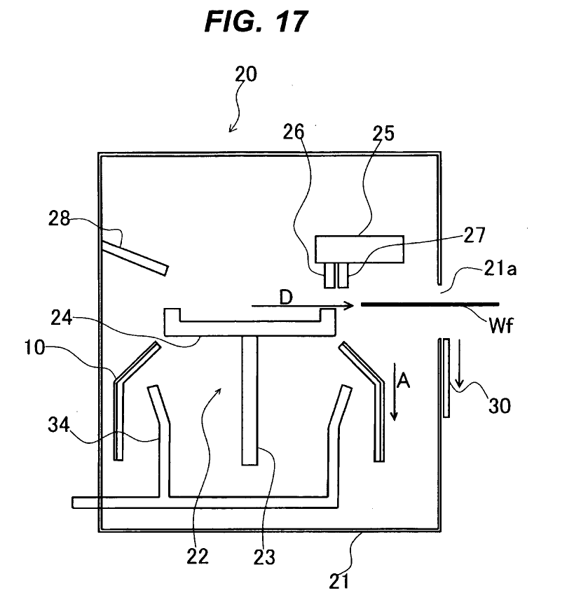

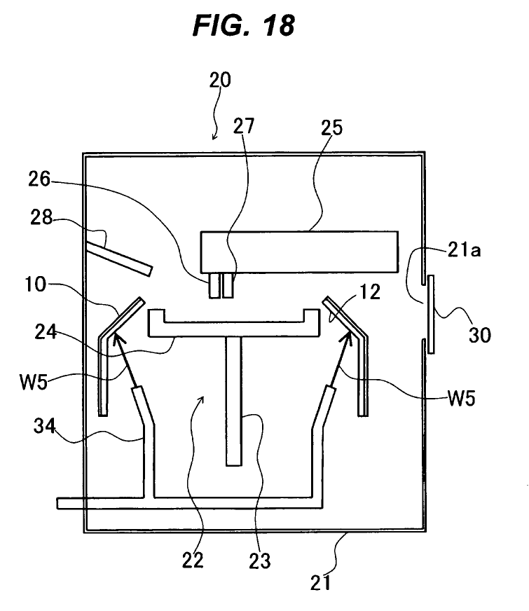

After completion of the drying process for the lower surface of the substrate Wf, the liquid-scattering prevention cup 10 is lowered and, at the same time, the shutter 30 is lowered to open the transfer port 21a of the cleaning tank 21, as shown in FIG. 17. The substrate Wf is then carried from the transfer port 21a out of the cleaning tank 21 by the transfer means, such as a robot arm. During idling of the substrate cleaning apparatus 20, in order to prevent drying of the hydrophilic material layer 12 in the inner surface of the liquid-scattering prevention cup 10, a rinsing liquid W5 is supplied from the cup-rinsing nozzles 34 to the hydrophilic material layer 12 to keep it in a wet state, as shown in FIG. 18.

Because the rinsing liquid W5 is continually supplied from the cup-rinsing nozzles 34 to the hydrophilic material layer 12 in the inner surface of the liquid-scattering prevention cup 10 during idling of the substrate cleaning apparatus 20, as described above, the hydrophilic material layer 12 can be kept wet without drying. When the substrate processing apparatus 20 ceases idling and enters into processing (cleaning) of a substrate Wf, liquid droplets, coming away from the substrate Wf, collide with the hydrophilic material layer 12 in the inner surface of the liquid-scattering prevention cup 10. The liquid droplets are then absorbed into the soft hydrophilic material layer 12 in a wet state. Bouncing of the liquid droplets on the layer is thus suppressed, and therefore re-attachment of the liquid droplets to the substrate Wf can be reduced.

As described hereinabove, by attaching the liquid-scattering prevention sheet 16, having the surface hydrophilic material layer 12, to the inner surface of the liquid-scattering prevention cup body 11 such that the hydrophilic material layer 12 is exposed inside the liquid-scattering prevention cup 10, and keeping the hydrophilic material layer 12 in a wet state, droplets of a rinsing liquid, coming away from a substrate Wf and colliding with the inner surface of the liquid-scattering prevention cup 10 during the drying process for the upper substrate surface or the drying process (spin-drying) for the lower substrate surface, are absorbed into the hydrophilic material layer 12 in a wet state, whereby bouncing of the liquid droplets on the inner surface of the liquid-scattering prevention cup 10 can be suppressed. This can significantly reduce re-attachment of the rinsing liquid to the dried substrate Wf.

In the liquid-scattering prevention cup 10 shown in FIG. 1 or 2, the liquid-scattering prevention sheet 16, having the surface hydrophilic material layer 12, is attached to the entire inner surface of the liquid-scattering prevention cup body 11 such that the hydrophilic material layer 12 is exposed inside the liquid-scattering prevention cup 10. The liquid-scattering prevention sheet 16 is provided to prevent bouncing of a liquid on the hydrophilic material layer 12 by utilizing the liquid-absorbing effect of the layer 12. Therefore, it is not necessary to provide the liquid-scattering prevention sheet 16 in those areas of the inner surface of the liquid-scattering prevention cup body 11 with which a liquid rarely collides, or a liquid may collide, but the liquid, bouncing off the inner surface, is not likely to re-attach to a dried surface of a substrate Wf.

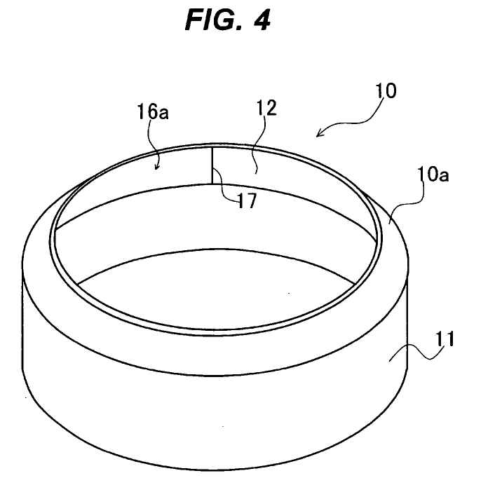

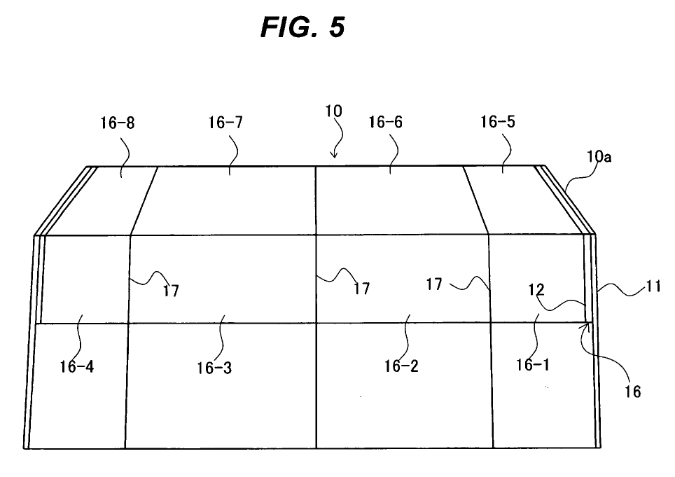

For example, it is possible to attach a single liquid-scattering prevention sheet 16a, which has been cut into a predetermined shape, as shown in FIG. 4, or a plurality of liquid-scattering prevention sheet pieces 16-1, 16-2, 16-3 . . . , which each have been cut into a predetermined shape, as shown in FIG. 5, to the inner surface of the liquid-scattering prevention cup body 11 in an area ranging from the upper end to a predetermined lower position. Thus, the liquid-scattering prevention sheet 16 may be attached, with the hydrophilic material layer 12 exposed, to that area in the inner surface of the liquid-scattering prevention cup body 11 with which a rinsing liquid, coming away from a substrate Wf, would collide and the liquid, bouncing off the inner surface, would possibly re-attach to the dried surface of the substrate Wf.

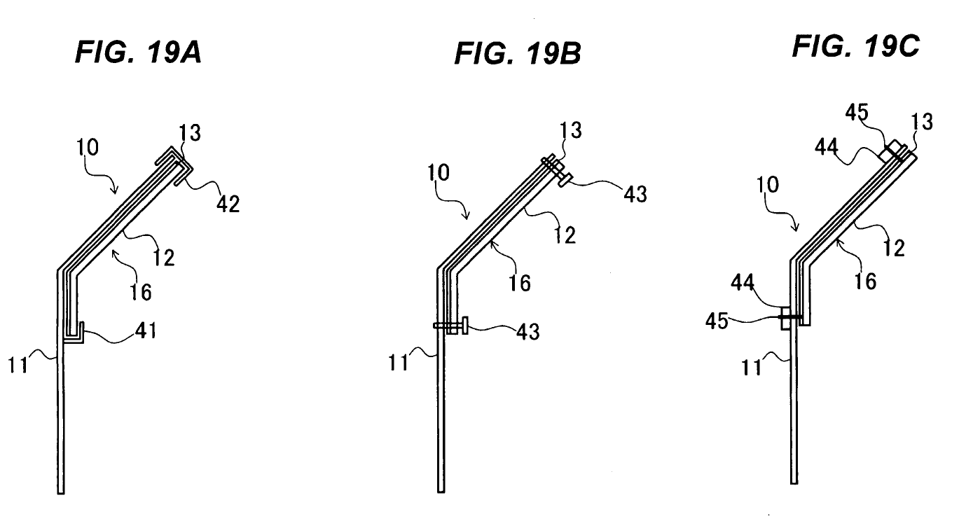

In the above embodiments, the liquid-scattering prevention sheet 16a or the liquid-scattering prevention sheet pieces 16-1, 16-2, 16-3 . . . , are attached to the inner surface of the liquid-scattering prevention cup body 11 by bonding the sheet material 13 to the inner surface of the liquid-scattering prevention cup body 11 with the adhesive 14. However, the liquid-scattering prevention sheet 16 may be attached to the liquid-scattering prevention cup body 11 by various other methods than the use of an adhesive, including the methods shown in FIGS. 19A through 19C.

The attachment method shown in FIG. 19A is as follows:

Sheet holding jigs 41 for holding the lower end of the liquid-scattering prevention sheet 16 are attached to predetermined positions on the inner surface of the liquid-scattering prevention cup body 11. The sheet material 13 of the liquid-scattering prevention sheet 16, which has been cut into a predetermined shape adapted for close contact with the inner surface of the liquid-scattering prevention cup body 11, is pressed against the inner surface of the liquid-scattering prevention cup body 11 such that the hydrophilic material layer 12 faces inwardly of the liquid-scattering prevention cup 10, and the upper end of the liquid-scattering prevention sheet 16 is secured to the upper end of the liquid-scattering prevention cup body 11 with clips 42. The liquid-scattering prevention sheet 16 can thus be attached to the inner surface of the liquid-scattering prevention cup body 11 such that the hydrophilic material layer 12 is exposed.

The attachment method shown in FIG. 19B is as follows:

The sheet material 13 of the liquid-scattering prevention sheet 16, which has been cut into a predetermined shape adapted for close contact with the inner surface of the liquid-scattering prevention cup body 11 in an area ranging from the upper end to a predetermined lower position, is pressed against the inner surface of the liquid-scattering prevention cup body 11 such that the hydrophilic material layer 12 faces inwardly of the liquid-scattering prevention cup 10, and the liquid-scattering prevention sheet 16 are secured to the liquid-scattering prevention cup body 11 with screws 43. The liquid-scattering prevention sheet 16 can thus be attached to the inner surface of the liquid-scattering prevention cup body 11 such that the hydrophilic material layer 12 is exposed.

The attachment method shown in FIG. 19C is as follows:

Bolts 45 are attached to the sheet material 13 of the liquid-scattering prevention sheet 16, which has been cut into a predetermined shape adapted for close contact with the inner surface of the liquid-scattering prevention cup body 11 in an area ranging from the upper end to a predetermined lower position. The bolts 45 are inserted into bolt holes formed in the inner surface of the liquid-scattering prevention cup body 11 with the hydrophilic material layer 12 facing inwardly of the liquid-scattering prevention cup 10, and nuts 44 are engaged with the tips of the bolts 45, projecting from the outer surface of the liquid-scattering prevention cup body 11, and the nuts 44 are tightened. The liquid-scattering prevention sheet 16 can thus be attached to the inner surface of the liquid-scattering prevention cup body 11 such that the hydrophilic material layer 12 is exposed.

By detachably attaching the liquid-scattering prevention sheet 16 to the inner surface of the liquid-scattering prevention cup body 11 by using an attachment jig, as shown in FIGS. 19A through 19C, it becomes possible to easily replace the liquid-scattering prevention sheet 16 when it is contaminated e.g., with particles, or easily clean the liquid-scattering prevention sheet 16 to remove contaminants. Maintenance works for the liquid-scattering prevention sheet 16 can thus be facilitated. Although in the embodiments shown in FIGS. 19A through 19C a single liquid-scattering prevention sheet 16 is attached to the inner surface of the liquid-scattering prevention cup body 11 by an attachment jig, it is possible to attach a plurality of liquid-scattering prevention sheet pieces to the liquid-scattering prevention cup body 11 by an attachment jig. Further, although in the embodiments shown in FIGS. 19A through 19C the liquid-scattering prevention sheet 16 is attached to the inner surface of the liquid-scattering prevention cup body 11 in an area ranging from the upper end to a predetermined lower position, it is possible to attach the liquid-scattering prevention sheet 16 to the entire area of the inner surface of the liquid-scattering prevention cup body 11.

As described above, the liquid-scattering prevention cup body 11 is generally cylindrical and has an inwardly inclined portion 10a at its upper end. Although in this embodiment the upper end and the lower end of the cylindrical portion of the liquid-scattering prevention cup body 11 have the same diameter, the diameter of the lower end may be slightly larger than the diameter of the upper end, as described above. In consideration of such shape of the liquid-scattering prevention cup body 11, the liquid-scattering prevention sheet 16 has been cut into such a shape as not produce a gap between the sheet material 13 of the liquid-scattering prevention sheet 16 and the inner surface of the liquid-scattering prevention cup body 11. Further, the sheet material 13, to which a PVA sponge is attached, is an elastic resin material such as PVC. Accordingly, when the liquid-scattering prevention sheet 16 is rolled and inserted into the liquid-scattering prevention cup body 11 and expanded in the liquid-scattering prevention cup body 11, the liquid-scattering prevention sheet 16, through the elastic restoring force of the sheet material 13, makes close contact with the inner surface of the liquid-scattering prevention cup body 11. This facilitates attachment of the liquid-scattering prevention sheet 16 to the inner surface of the liquid-scattering prevention cup body 11 by an adhesive or an attachment jig. When the sheet material 13 has a strong elastic restoring force, the liquid-scattering prevention sheet 16 can be attached to the inner surface of the liquid-scattering prevention cup body 11 only by the elastic restoring force of the sheet material 13 or by additionally using a simple attachment jig.

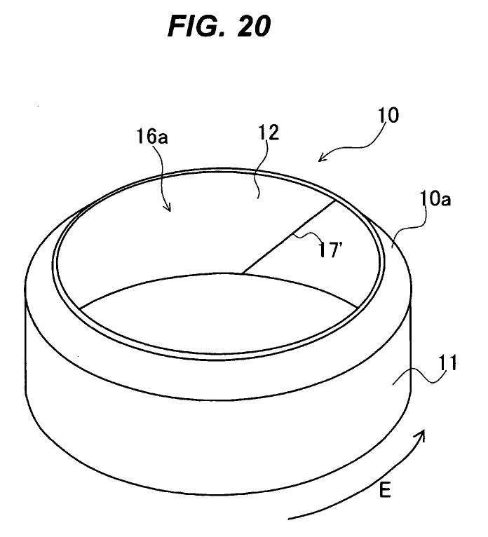

Although in the liquid-scattering prevention cup 10 shown in FIG. 1, the liquid-scattering prevention sheet 16a is attached to the inner surface of the liquid-scattering prevention cup body 11 such that the seam 17 is formed vertically, it is also possible, as shown in FIG. 20, to attach the liquid-scattering prevention sheet 16a to the inner surface of the liquid-scattering prevention cup body 11 such that a seam 17′ is inclined from the vertical direction toward a direction opposite to the rotating direction, shown by arrow E, of the substrate rotating mechanism 22 (see FIG. 13).

Such an inclined seam 17′ can reduce bouncing of a rinsing liquid on the seam 17′, thereby reducing the formation of watermarks on a surface of a substrate Wf.

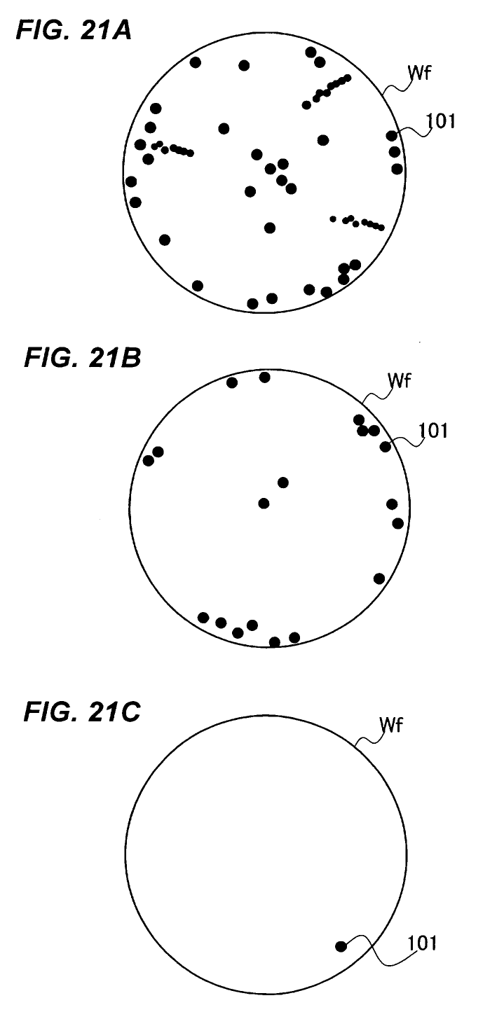

FIGS. 21A through 21C are diagrams illustrating the formation of watermarks on a surface of a semiconductor wafer Wf as observed when the wafer Wf is cleaned by the substrate processing apparatus shown in FIG. 6. FIG. 21A shows the formation of watermarks in the case where the hydrophilic material layer 12 is not provided in the inner surface of the liquid-scattering prevention cup 10; FIG. 21B shows the formation of watermarks in the case where the hydrophilic material layer 12 is provided in the inner surface of the liquid-scattering prevention cup 10, but the hydrophilic material layer 12 is in a dry state at the start of cleaning; and FIG. 21C shows the formation of watermarks in the case where the hydrophilic material layer 12 is provided in the inner surface of the liquid-scattering prevention cup 10, and the hydrophilic material layer 12 is in a wet state at the start of cleaning. As can be seen from the Figures, the number of watermarks 101, formed on a surface of a semiconductor wafer Wf after cleaning, can be significantly decreased by providing the hydrophilic material layer 12 in the inner surface of the liquid-scattering prevention cup 10 and making the hydrophilic material layer 12 in a wet state prior to the start of cleaning.

Watermarks 101 formed on a semiconductor wafer Wf can cause a leak or poor adhesion in the watermark portion of the semiconductor wafer Wf, leading to lowering of the product yield. The substrate processing apparatus and the method for operating the apparatus, according to the present invention, can significantly reduce the formation of watermarks 101, and can therefore considerably increase the product yield.

While the present invention has been described with reference to the embodiments thereof, it will be understood by those skilled in the art that the present invention is not limited to the particular embodiments described above, but it is intended to cover modifications within the general inventive concept described herein. For example, while the present invention has been described with reference to the substrate cleaning apparatus for cleaning a semiconductor wafer, the liquid-scattering prevention cup, the substrate processing apparatus using the liquid-scattering prevention cup and the method for operating the apparatus, according to the present invention, can also be applied to a cleaning apparatus for a substrate other than a semiconductor wafer, such as a glass substrate, a liquid crystal panel, etc. Further, the present invention is not limited to a substrate cleaning apparatus, but is applicable to any substrate processing apparatus that includes a substrate rotating mechanism for holding and rotating a substrate, and carries out processing of the substrate by supplying a processing liquid to the rotating substrate.

What is claimed is:

1. A liquid-scattering prevention cup, provided in a substrate processing apparatus comprising a substrate rotating mechanism for holding and rotating a substrate, and the liquid-scattering prevention cup, disposed such that it surrounds the periphery of the substrate held by the substrate rotating mechanism, for preventing scattering of liquid droplets coming away from the rotating substrate, said liquid-scattering prevention cup comprising:
a liquid-scattering prevention cup body; and
a liquid-scattering prevention sheet, having a surface hydrophilic material layer, attached to an entire area or a predetermined area of an inner surface of the liquid-scattering prevention cup body,
wherein the liquid-scattering prevention sheet has been attached to the liquid-scattering prevention cup body by an attachment such that the hydrophilic material layer is exposed.

2. The liquid-scattering prevention cup according to claim 1, wherein the attachment attaches the opposite side of the liquid-scattering prevention sheet from the hydrophilic material layer to the inner surface of the liquid-scattering prevention cup body with an adhesive.

3. The liquid-scattering prevention cup according to claim 1, wherein the attachment detachably attaches the opposite side of the liquid-scattering prevention sheet from the hydrophilic material layer to the inner surface of the liquid-scattering prevention cup body by using an attachment jig.

4. The liquid-scattering prevention cup according to claim 1, wherein the liquid-scattering prevention sheet is comprised of a plurality of liquid-scattering prevention sheet pieces, each having been cut into a predetermined shape adapted for close contact with the inner surface of the liquid-scattering prevention cup body, and each comprising a resin sheet and the surface hydrophilic material layer attached to the resin sheet via an adhesive.

5. The liquid-scattering prevention cup according to claim 1, wherein the liquid-scattering prevention sheet has been cut into a predetermined shape adapted for close contact with the inner surface of the liquid-scattering prevention cup body, comprises an elastic sheet and the surface hydrophilic material layer attached to the elastic sheet via an adhesive, and has been attached to the inner surface of the liquid-scattering prevention cup body by inserting it into the liquid-scattering prevention cup body through elastic deformation of the liquid-scattering prevention sheet, and bringing the elastic sheet into close contact with the inner surface of liquid-scattering prevention cup body through the elastic restoring force of the elastic sheet.

6. The liquid-scattering prevention cup according to claim 1, wherein the liquid-scattering prevention sheet, attached to the inner surface of the liquid-scattering prevention cup body, has a seam which is inclined from the vertical direction of the liquid-scattering prevention cup body toward a direction opposite to the rotating direction of the substrate rotating mechanism.

7. A substrate processing apparatus comprising:
a substrate rotating mechanism for holding and rotating a substrate; and
a liquid-scattering prevention cup, disposed such that it surrounds a periphery of the substrate held by the substrate rotating mechanism, for preventing scattering of liquid droplets coming away from the rotating substrate,
wherein a hydrophilic material layer for preventing liquid droplets, coming away from the rotating substrate, from bouncing off an inner surface of the liquid-scattering prevention cup is provided in part or all of the inner surface of the liquid-scattering prevention cup, and
wherein the substrate processing apparatus includes a wetting section for supplying a rinsing liquid to the hydrophilic material layer to keep the hydrophilic material layer in a wet state.

8. The substrate processing apparatus according to claim 7, wherein the wetting section includes a plurality of rinsing liquid spray nozzles disposed such that the rinsing liquid is uniformly supplied to a surface of the hydrophilic material layer.

9. The substrate processing apparatus according to claim 8, wherein the rinsing liquid spray nozzles are disposed below the liquid-scattering prevention cup.

10. The substrate processing apparatus according to claim 7, wherein the rinsing liquid spray nozzles are each provided with a spray angle adjustment mechanism for adjusting the angle of spray of the rinsing liquid to adjust the position of a spray spot on a surface of the hydrophilic material layer.

11. A method for operating a substrate processing apparatus comprising a substrate rotating mechanism for holding and rotating a substrate, and a liquid-scattering prevention cup, disposed such that it surrounds the periphery of the substrate held by the substrate rotating mechanism, for preventing scattering of liquid droplets coming away from the rotating substrate, said method comprising:
providing in part or all of an inner surface of the liquid-scattering prevention cup a hydrophilic material layer for preventing liquid droplets, coming away from the rotating substrate, from bouncing off the inner surface of the liquid-scattering prevention cup; and
supplying a rinsing liquid from a rinsing liquid supply section to the hydrophilic material layer during idling of the apparatus to keep the hydrophilic material layer in a wet state.

12. The method for operating a substrate processing apparatus according to claim 11, wherein the rinsing liquid supply section includes a rinsing liquid spray nozzle.
